(19) United States
(12) Patent Application Publication
(10) Pub. No.: US 2025/0320331 A1
(43) Pub. Date: Oct. 16, 2025

(54) CONDUCTING POLYMERS AND USE IN ELECTRODES FOR HIGH CAPACITY, LOW-COST, ENERGY STORAGE

(71) Applicant: POLYJOULE, INC., Billerica, MA (US)

(72) Inventors: Eli Paster, Billerica, MA (US); Taizoon Canteenwala, Billerica, MA (US); Mackenzie King, Billerica, MA (US)

(21) Appl. No.: 18/865,390

(22) PCT Filed: May 16, 2023
(86) PCT No.: PCT/US2023/067033

§ 371 Date: Nov. 13, 2024

Related U.S. Application Data
(60) Provisional application No. 63/342,243, filed on May 16, 2022.

(51) Int. Cl. C08G 61/12; H01G 11/06; H01G 11/48; H01G 11/68; H01M 4/62; H01M 4/66

(52) U.S. Cl. CPC C08G 61/126; H01G 11/06; H01G 11/48; H01G 11/68; H01M 4/622; H01M 4/661; C08G 2261/122; C08G 2261/1422; C08G 2261/312; C08G 2261/3223; C08G 2261/43; C08G 2261/514

(57) ABSTRACT

Provided are electrically conductive polymer materials that have improved long chain conductivity as well as their use in electrochemical cells and other devices. The electrically conductive polymers may be characterized by a kinking factor of 0.25 or lower representing reduced levels or the absence of contaminants or structures that interrupt conductivity in prior polymer materials. In some aspects, an electrically conductive polymer includes a cap that serves to further promote conductivity of the polymer. Also provided are electrochemical cells that incorporate the electrically conductive polymers as provided herein and methods of manufacturing such polymers.

### CROSS REFERENCE TO RELATED APPLICATIONS

This application depends from and claims priority to U.S. Provisional Patent Application No. 63/342,243 filed May 16, 2022, the entire contents of which are incorporated herein by reference.

### FIELD

This disclosure related to the field of energy storage. More specifically, this disclosure relates to materials and systems that employ those materials for electrochemical energy storage and use.

### BACKGROUND

Electrochemical energy storage needs have increased dramatically in recent years. The more recent acceptance of electrically powered automobiles and mobile devices continues to demand new technologies that can increase range and performance. These mobile platforms, however, are not the only source for energy storage demands.

The size of the electrical grid in the US and the world also continues to increase. Generating power for the ever increasing demand for electricity continues to be a challenge. The use of renewable energy sources is desired not only due to its environmental friendliness, but also for use in remote areas or for in other situations where use of fossil fuels is prohibitive. When typical renewable energy sources are used for power, such as wind or solar, these mechanisms of generating power are subject to weather and other conditions that can reduce the availability of electricity, often at times when such demand is highest. Thus, finding ways to store large amounts of energy are paramount to providing continuous energy. Storing electrical energy at times when power sources are plentiful and releasing that energy when needed at times when power sources are inadequate creates a system whereby steady energy can be supplied to the consumer.

Supercapacitors represent a bridge between batteries and conventional capacitors. Supercapacitors have the capability to deliver energy quickly and on demand. This allows the use of supercapcitor systems in a microgrid that can deliver the needed power to a smaller area when needed or when the general power grid is incapable of satisfying the energy needs for a particular time. Finding new technologies that can further increase the ability of batteries and supercapcitors to deliver needed energy on demand and store large amounts of that energy when not required are, therefore, greatly needed.

As such, there is a need for improved materials and devices for storage and/or delivery of electrical energy on demand. This disclosure provides new materials with superb energy density and electrical conductivity thereby enabling improved energy storage and delivery systems such as batteries or supercapacitors. These and other advantages of the disclosure will be apparent from the drawings, discussion, and description that follow.

### BRIEF DESCRIPTION OF THE DRAWINGS

FIG. 1 illustrates exemplary electrically conductive polymers as provided herein and depicting systems that are sufficiently conducting and various reasons for the presence of a conductivity interrupting kink.

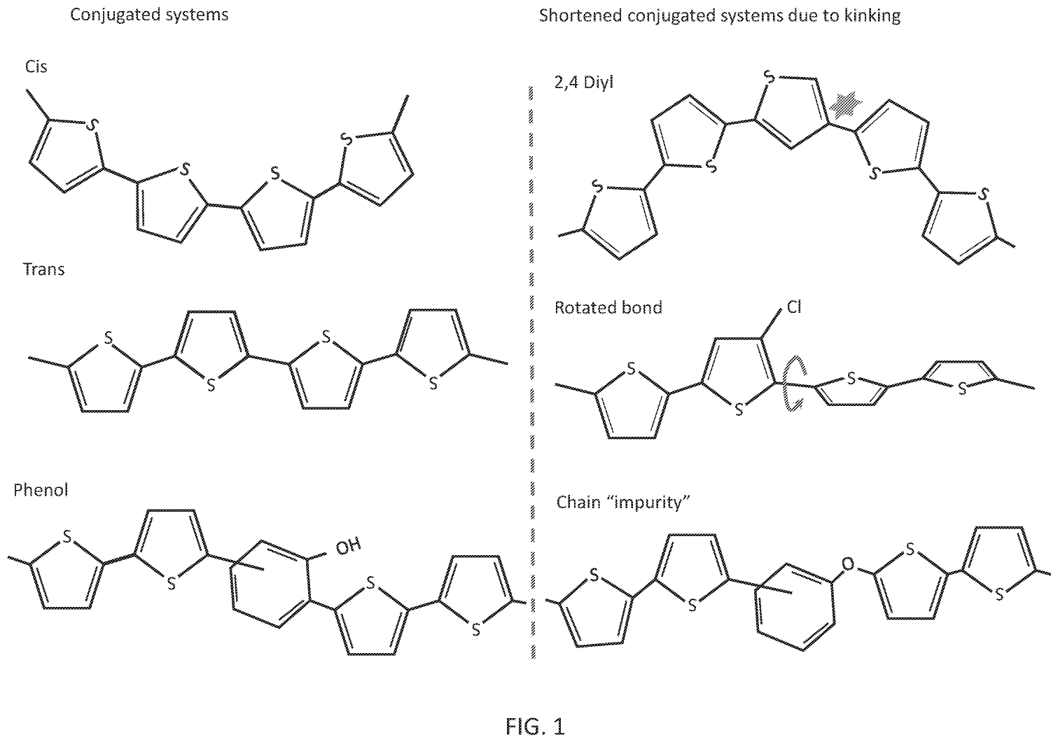

FIG. 2 illustrates FTIR studies of an exemplary electrically conductive polymer as provided herein demonstrating advantages of short synthesis times of less than 1 hour.

FIG. 3 illustrates improved energy density with lower kinking within an exemplary electrically conductive polymer.

FIG. 4 illustrates FTIR absorbances of the ester C═O absorbance peak at 1740 cm⁻¹ relative to added phenol concentrations in an exemplary electrically conductive polymer showing excellent conjugation at levels even below 5 wt % phenol relative to chain monomers.

FIG. 5 illustrates the presence of ester peaks increasing with increasing conjugation in exemplary electrically conductive polymers as provided herein.

FIG. 6 illustrates that as conjugation increases in exemplary electrically conductive polymers as provided herein also does the energy density as measured in cells employing the electrically conductive polymer.

FIG. 7 illustrates the increased ester substituent present in an electrically conductive polymer as provided herein correlates with improved energy density.

FIG. 8 illustrates that the presence of Cl ions in exemplary electrically conductive polymers as provided herein correlates with reduced conjugation.

FIG. 9 illustrates that improved conjugation is achieved in exemplary electrically conductive polymers as provided herein at lower residual Fe levels.

### DETAILED DESCRIPTION

Provided in this disclosure are new polymer materials that can be employed in electrodes of devices such as batteries or supercapacitors for improved energy density and rapid delivery of electrical energy when desired. The materials as provided herein improve energy storage in part by improving electron transport through the polymer through either reducing kinking of the polymer that otherwise retards electron transport, and/or by employing capping or modifiers that further promote electron transport within the polymer itself.

When atomic percentages (at %) are presented and not otherwise defined, the atomic percentages are presented on the basis of the amount of all elements in the described material other than hydrogen and oxygen.

A [symbol] polymer [symbol] as used herein is a plurality of monomers covalently linked in a chain of two or more such monomers. A polymer may be a linkage of like monomers with identical chemical structure (homomeric) or may be linkage including one or more monomers with differing structure (heteromeric).

A [symbol] monomer [symbol] as used herein is a discrete chemical structure that may be linked with other such monomers in a chain to form a polymer.

A [symbol] cap [symbol] as defined herein is one or more terminating monomers with differing structure than adjacent monomers wherein the one or more terminating monomers are present on an end of a polymer chain.

[symbol] Aromatic [symbol] as used herein includes a structure with one or more rings with delocalized pi electrons around the ring.

The term [symbol] conjugated [symbol] as used herein is a system of connected p-orbitals with delocalized electrons. A conjugated system may arise as the result of alternating single and double bonds in a chemical structure.

The polymeric materials provided herein may be used as an active or contributing component of an electrode such as is suitable for use in a battery or supercapacitor. The polymeric materials as provided herein provide excellent energy density and capability to rapidly deliver electrical power on demand. The polymers function by one or more unique aspects. Optionally, a polymer may improve electrical conductivity through the system by reducing the electrical kinking that occurs within polymeric materials themselves. Alternatively, or in addition, the polymers as provided herein may include a cap on or more ends of the polymer chain that also serves to improve electrical conductivity and energy density deliverable by the polymer.

The polymers as provided herein may be used as a component of an electrode, battery, supercapacitor, or any combination thereof. As such, a polymer may include a plurality of monomers, wherein the plurality of monomers are conjugated in a polymeric linkage with a kinking factor of 0.25 or less. Kinking within a conjugated polymer may arise due to one or more intervening structures or orientations of monomers that reduce or eliminate the ability to transport an electron through the polymer. Such kinking may occur due to the presence of an introduced 2,4 diyl, the rotation of a bond between monomers that interrupts electron transport, or by the presence of an impurity whereby an impurity is a chemical structure that alters or eliminates electron transport though the chain (e.g. intermediate non-conjugated monomer, metal or halogen). As used herein, a [symbol] kinking factor [symbol] is a measure of a structural characteristic of the polymer that leads to an observed kink within a polymer. Specifically, a kinking factor as provided herein is the peak intensity ratio of 682 cm⁻¹/700 cm⁻¹ measured by Raman spectroscopy. It was found that polymers with a kinking factor of 0.25 or lower are particularly well suited for use in electrodes such as those that may be employed in energy storage devices. As such, a polymer as provided herein optionally has a kinking factor of 0.25 or less. Optionally, a kinking factor is 0.20 or lower. Optionally, a kinking factor is equal to or lower than 0.25, 0.24, 0.23, 0.22, 0.21, 0.2, 0.19, 0.18, 0.17, 0.16, 0.15, 0.14, 0.13, 0.12, 0.11, 0.1, 0.09, 0.08, 0.07, 0.06, 0.05, 0.04, 0.03, 0.02, or 0.01. Optionally, a kinking factor is at or between 0.25 and 0.01, optionally at or between 0.02 and 0.01, optionally at or between 0.15and 0.01.

A polymer is optionally incorporated into a film that is optionally standing alone or in electrical communication with an electrically conductive substrate such as a current collector. A film of electrically conductive polymer is optionally continuous or discontinuous. A film may be defined by a suitable thickness. A thickness of film is optionally from 0.1 micrometers to 0.4 millimeters, or any value or range therebetween. Optionally, a film thickness is 0.1 micrometers to 0.4 millimeter, optionally 0.1 micrometers to 0.3 millimeters, optionally 0.1 micrometers to 0.2 millimeters. In other aspects, a film thickness is 0.5 micrometers to 0.4 millimeters, optionally 0.5 micrometers to 0.3 millimeters. Further, a film of electrically conductive polymer may be defined by a robust Youngls elastic modulus, optionally at or equal to 1 GPa or greater, optionally 1 GPa to 60 GPa.

It is appreciated that standard film processing techniques may be used in the formation of a film of electrically conductive material. Optionally, a film may be produced by rolling and/or pressing the electrically conductive polymer into a film. Optionally, the electrically conductive polymer is produced or made into a slurry or semi-solid composed of slurry and granular particles may be coated onto a conductive substrate and dried. The electrically conductive polymer as provided herein, however, may be formed into granules that then are pressed or otherwise configured into a film for use in an electrode.

As provided herein, an electrically conductive polymer optionally includes a plurality of chain monomers. In some aspects, the plurality of chain monomers is homomeric meaning that, other than the presence of a cap or other intervening structure, the conjugated sections of the polymer contain predominantly the same type of chain monomer. Alternatively, the plurality of chain monomers is heteromeric meaning that the conjugated chain monomer system includes chain monomers of differing structure, wherein the differing structure excludes the structure of a cap when present.

A monomer (e.g. chain or cap) optionally is or includes a cyclic structure, optionally a ring structure. A ring structure may include 3, 4, 5, 6, or members within the ring. Optionally, a monomer is or includes a five membered ring structure. Optionally, a monomer is or includes a six membered ring structure. The monomers, optionally chain monomers, however, include a conjugation within the monomer structure, and/or with one or more adjacent monomers so as to form a conjugated polymer structure. As such, a monomer optionally is or includes an aromatic structure to form an aromatic monomer.

In some aspects, the chain monomers may be or include a heterocyclic structure wherein one or more heteroatoms are present within the monomer. A heteroatom is optionally N, O, S, P, or any combination thereof within the ring structure. In some aspects, a heteroatom is S. in some aspects, a heteroatom is O. Optionally, a heteroatom is N. Optionally, a polymer excludes a heterocyclic ring structure with a heteroatom of O, N or P.

As such, a chain monomer as used in a polymer as provided herein is optionally a substituted or unsubstituted thiophene, benzothiophene, thianthrene, furan, tetrahydrofuran, pyran, isobenzofuran, chromene, xanthene, phenoxathiin, pyrrole, dihydropyrrole, pyrrolidine, imidazole, pyrazole, pyrazine, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, triazole, tetrazole, oxazole, isoxazole, thiazole, isothiazole, phenanthridine, acridine, pyrimidine, phenanthroline, phenazine, phenarsazine, phenothiazine, furazan, phenoxazine, pyrrolidine, oxolane, thiolane, oxazole, oxazine, piperidine, homopiperidine (hexamethyleneimine), piperazine (e.g., N-methyl piperazine), morpholine, lactones, lactams such as azetidinones and pyrrolidinones, sultams, sultones, other saturated and/or unsaturated derivatives thereof. Optionally, a chain monomer includes or is a pyrrole, thiophene, aniline, phenyl, mixtures thereof, and/or derivatives thereof. Optionally, a plurality of chain monomers includes a thiophene, a phenol, or combinations thereof. Optionally, a polymer includes a plurality of any of the foregoing that may include a cap that includes one or more cap monomers of phenol, optionally a polythiophene with a cap that includes one or more cap monomers of phenol.

An electrically conductive polymer may include one or more chain monomers with a non-hydrogen substituent. A non-hydrogen substituent is a substituent that includes at least one atom that is not a hydrogen or excludes a hydrogen within the substituent. Illustrative examples of substituents as provided herein include but are not limited to substituents include, but are not limited to a halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, [symbol] CF₃, [symbol] CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, alkylaminoalkylcarboxy, aminocarboxamidoalkyl, cyano, alkoxyalkyl, perhaloalkyl, or arylalkyloxyalkyl. Optionally, a substituent is or includes a halogen atom, and/or a linear or branched alkyl, alkoxy, or alkyl ester group having from 1 to 20 carbon atoms, optionally 1-5 carbon atoms, optionally 1-2 carbon atoms. In some aspects, a substituent includes C1-C5 alkyl ester, optionally a C1 alkyl ester, optionally a C2 alkyl ester, optionally a C3 alkyl ester, optionally a C4 alkyl ester. In other aspects, a non-hydrogen substituent is or includes a halogen. A halogen is optionally F, Cl, Br, or I. A chain monomer optionally includes one or more substituents, optionally 1, 2, 3, or more. Optionally, a chain monomer includes one substituent, optionally a halogen or a linear or branched alkyl, alkoxy, or alkyl ester group having from 1 to 20 carbon atoms. It was found that aperiodic inclusion of one or more substituents within the electrically conductive polymer at one or more chain monomers or other location creates a system with consistently better electrochemical activity of the polymer when incorporated into an electrode. The one or more substituents is optionally present within the polymer chain at 0.01 mol % relative to the chain monomer total moles to 10 mole % or greater. Optionally, the one or more substituents is present within the polymer at 0.02 mol %, optionally 0.05 mole %, optionally 0.08 mol %, optionally 0.1 mole %, optionally 0.2 mol %, optionally 0.3 mol %, optionally 0.4 mol %, optionally 0.5 mol %, optionally 0.6 mol %, optionally 0.7 mol %, optionally 0.8 mol %, optionally 0.9 mol %, optionally 1 mole %, optionally 2 mol %, optionally 3 mol %, optionally 4 mol %, optionally 5 mol %, optionally 6 mol %, optionally 7 mol %, optionally 8 mol %, optionally 9 mol %, optionally 10 mol %, or greater.

In some aspects, a substituent is an alkyl ester, optionally a C1-C5 alkyl ester, optionally a C1 alkyl ester, optionally a C2 alkyl ester, optionally a C3 alkyl ester, optionally a C4 alkyl ester. An alkyl ester is optionally present on a chain monomer, a cap monomer, or both. Optionally, an alkyl ester is present on a chain monomer. Optionally, an alkyl ester is present relative to chain monomer at 0.01 mol % relative to the chain monomer total moles to 10 mole % or greater. Optionally, the alkyl ester is present within the polymer at 0.02 mol %, optionally 0.05 mole %, optionally 0.08 mol %, optionally 0.1 mole %, optionally 0.2 mol %, optionally 0.3 mol %, optionally 0.4 mol %, optionally 0.5 mol %, optionally 0.6 mol %, optionally 0.7 mol %, optionally 0.8 mol %, optionally 0.9 mol %, optionally 1 mole %, optionally 2 mol %, optionally 3 mol %, optionally 4 mol %, optionally 5 mol %, optionally 6 mol %, optionally 7 mol %, optionally 8 mol %, optionally 9 mol %, optionally 10 mol %, or greater.

In some aspects, a substituent is halogen, optionally a F, Cl, Br, or I. A halogen is optionally present on a chain monomer, a cap monomer, or both. Optionally, a halogen is present on a chain monomer. Optionally, halogen is present relative to chain monomer at 0.01 mol % relative to the chain monomer total moles to 10 mole % or greater. Optionally, the halogen is present within the polymer at 0.02 mol %, optionally 0.05 mole %, optionally 0.08 mol %, optionally 0.1 mole %, optionally 0.2 mol %, optionally 0.3 mol %, optionally 0.4 mol %, optionally 0.5 mol %, optionally 0.6 mol %, optionally 0.7 mol %, optionally 0.8 mol %, optionally 0.9 mol %, optionally 1 mole %, optionally 2 mol %, optionally 3 mol %, optionally 4 mol %, optionally 5 mol %, optionally 6 mol %, optionally 7 mol %, optionally 8 mol %, optionally 9 mol %, optionally 10 mol %, or greater. In particular aspects, a halogen substituent is a chloride. Optionally, chloride is present relative to chain monomer at 0.01 mol % relative to the chain monomer total moles to 10 mole % or greater. Optionally, the halogen is present within the polymer at 0.02 mol %, optionally 0.05 mole %, optionally 0.08 mol %, optionally 0.1 mole %, optionally 0.2 mol %, optionally 0.3 mol %, optionally 0.4 mol %, optionally 0.5 mol %, optionally 0.6 mol %, optionally 0.7 mol %, optionally 0.8 mol %, optionally 0.9 mol %, optionally 1 mole %, optionally 2 mol %, optionally 3 mol %, optionally 4 mol %, optionally 5 mol %, optionally 6 mol %, optionally 7 mol %, optionally 8 mol %, optionally 9 mol %, optionally 10 mol %, or greater.

It is noted that a polymer may include a plurality of chain monomers some of which may include one or more heteroatoms, one or more substituents, or both. In some aspects, one or more of the chain monomers in the electrically conducting polymer includes a substituent that may be a halogen, alkyl ester or combinations thereof, and optionally wherein one or more of said chain monomers comprises a sulfur as a heteroatom in a ring structure. It was found that in such situations, a molar percentage of halogen to sulfur or other heteroatom is 0.25 or lower. Optionally the molar percentage of halogen to sulfur or other heteroatom is 0.20 or lower, optionally 0.15 or lower, optionally 0.1 or lower, optionally 0.05 or lower, optionally 0.01 or lower.

As introduced above, an electrically conductive polymer as provided herein may have a kinking factor of 0.25 or less or may be characterized by the presence a cap on one or more ends of the polymer chain, or the electrically conductive polymer may have both a kinking factor of 0.25 or less and the presence of a cap on one or more ends of the polymer. A cap as used herein includes a structure that includes one or more groups that prevent association of or replaces an acid group on the terminus of the polymer structure. It was found that the presence of acid groups on the terminus of electrically conductive polymers correlates with relatively poor electrochemical activity when used in an electrode whereas including a cap that has a non-acid substituent on the ends of the polymers allows control over the beneficial chemistry and bolstering electrochemical activity of the polymer material when used in an electrode for electrochemical energy storage applications.

As such, a polymer as provided herein optionally includes a cap. A cap may be on one end of a polymer or both ends of a polymer. A cap is optionally present on the terminus of a branch within the polymer, if present. A cap optionally includes one or more cap monomers, optionally a substituted or unsubstituted aromatic moiety. In some aspects, a cap monomer includes a ring structure, optionally 5 or 6 membered ring structure that optionally includes a non-hydrogen substituent that is not an acid group. In some aspects, a cap comprises an aromatic ring that includes a substituent that is a halogen atom, or linear or branched alkyl, alkoxy, or alkyl ester group having from 1 to 20 carbon atoms, optionally 1 to 5 carbon atoms. Optionally, a cap includes or is a phenolic moiety with a phenyl core and one or more substituents that are not an acid group. The one or more substituents on the phenolic moiety optionally include a hydrogen (e.g. phenol), halogen, or a linear or branched alkyl, alkoxy, or alkyl ester group having from 1 to 20 carbon atoms, optionally 1 to 5 carbon atoms. Specific examples of a halogen on a cap include F, Cl, Br, and I. Specific non-halogen substituents on a cap include a hydroxyl, or a linear or branched alkyl, alkoxy, or alkyl ester group having from 1 to 20 carbon atoms, optionally 1 to 5 carbon atoms. Optionally, a substituent on a cap monomer includes an alkyl ester. Optionally, a monomer of a cap includes a chloride or alkyl ester, optionally methyl ester or ethyl ester. Optionally, a monomer of a cap is a phenolic moiety that is phenol or a phenyl with a chloride, methyl ester, ethyl ester or any combination thereof.

A cap includes one or more cap monomers. The number of cap monomers present in a cap is optionally from 1 to 10, or any value or range therebetween, optionally 2 to 10 or more. Optionally, the number of cap monomers is 2, 3, 4, 5, 6, 7, 8, or more.

Optionally, an electrically conducting polymer has a structure that may be as found in Formula I:

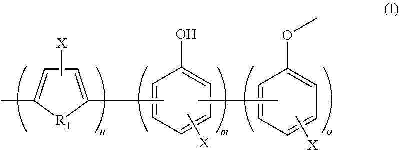

wherein R1 is C or a heteroatom, optionally N, O, S, P or other, n is any value greater than 2 and of sufficient conjugation to provide a ratio of absorbance at 1437 cm⁻¹ to 1490 cm⁻¹ by FTIR of 1.1 or less, m is any value from 0 to 10 and o is any value from 0 to 10, wherein at least one of m or o is 1 or greater and optionally wherein m+o is 2 or greater, X is each independently a nullity, H, a halogen, OH, or linear or branched alkyl, alkoxy, or alkyl ester group having from 1 to 20 carbon atoms, optionally 1 to 5 carbon atoms. Optionally, m+o is such that the total m+o is 10 weight percent or less relative to the polymer, optionally wherein m+o is 5 wt % to 7 wt % relative to the polymer.

Optionally, an electrically conductive polymer has the following structure of Formula II:

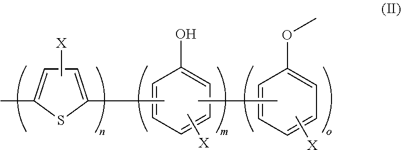

wherein n is any value greater than 2 and of sufficient conjugation to provide a ratio of absorbance at 1437 cm⁻¹ and 1490 cm⁻¹ by FTIR of 1.1 or less, m is any value from 0 to 10 and o is any value from 0 to 10, wherein at least one of m or o is 1 or greater and optionally wherein m+o is 2 or greater, X and Y are each independently a nullity, H, a halogen, OH, or linear or branched alkyl, alkoxy, or alkyl ester group having from 1 to 20 carbon atoms, optionally 1 to 5 carbon atoms. Optionally, m+o is such that the total m=o is 10 weight percent or less relative to the polymer, optionally wherein m+o is 5 wt % to 7 wt % relative to the polymer. Optionally, wherein Y is H, halogen, or an alkyl ester and X is H or a halogen and wherein m is any value from 0 to 10 and o is any value from 0 to 10, optionally wherein at least one of m or o is 1 or greater, and wherein m+o is optionally 2 or greater. Optionally, m+o is such that the total m+o is 10 weight percent or less relative to the polymer, optionally wherein m+o is 5 wt % to 7 wt % relative to the polymer.

It was found for synthesis of electrically conducing polymers with a cap that by carefully tailoring not only the amount of cap monomers but also the time and in some cases the temperature of synthesis, that cap monomers can be segregated to the termini and not incorporated significantly if at all in the growing polymer structure itself. For example, it was found that by including cap monomers at a concentration of 10 mole percent or lower relative to the other chain monomers in the system and keeping the reaction time to less than 24 hours that the cap monomers preferentially localized to the termini of the polymer thereby not interrupting the electrical conductivity throughout and preserving electrochemical activity of the resulting polymers.

As such, synthesis of an electrically conducting polymer as provided herein may be achieved by any of a variety of suitable methods with careful control of relative amounts of cap monomers to chain monomers and reaction conditions. For example, in some embodiments, a method of synthesizing an electrically conductive polymer includes intermixing plurality of chain monomers optionally in the presence of one or more cap monomers to form the electrically conductive polymer at a polymerization temperature and for a polymerization time, optionally of 24 hours or less with the proviso that the cap monomers are structurally different than the chain monomers. The process optionally includes the presence of an oxidant and a solvent to promote polymerization of the monomers into the resulting electrically conducting polymer.

A process of synthesizing an electrically conducting polymer is optionally performed for a polymerization time of 24 hours or less. Optionally, a polymerization time is at or less than 23, 22, 21, 20, 19, 18, 17, 16, 15, 14, 13, 12, 11, 10, 9, 8, 7, 6, 5, 4, 3, 2, or 1 hour(s). In some aspects, a polymerization time is at or less than optionally 1 hour, optionally 50 minutes, optionally 40 minutes, optionally 30 minutes, optionally 20 minutes, optionally 15 minutes, optionally 10 minutes. It is appreciated that the localization of the cap monomers at the cap position is bolstered by a shorter polymerization time in addition to the mole ratio of the cap monomers to other monomers of 10:100 or lower. For example, by using one or more cap monomers to polymer monomers at a ratio of 10:100 or less and a polymerization time of 1 hour or less, optionally 5 minutes to 1 hour, it was found that electrochemical performance of the resulting electrically conducting polymer when used in an electrode were improved.

Similarly, performance was also improved by controlling the temperature in addition to the presence and relative amount of one or more chain monomers to cap monomers at a ratio of 100:10 or less. Optionally, a polymerization temperature does not exceed 200° C., optionally no greater than 190° C., optionally no greater than 180° C. The polymerization temperature is 200° C. or less, the polymerization time is 1 hour or less, and the ratio of one or more cap monomers to chain monomers is 100:1 or less.

When a cap is desired on an electrically conductive polymer as provided herein, synthesis of the polymer may be using a molar ratio of cap monomers to chain monomers of 10:100 or less. Optionally, the molar ratio of cap monomers to chain monomers is equal to or less than 9:100, optionally 8:100, optionally 7:100, optionally 6:100, optionally 5:100, optionally 4:100, optionally 3:100, optionally 2:100, optionally 1:100, optionally 0.9:100, optionally 0.8:100, optionally 0.7:100, optionally 0.6:100, optionally 0.5:100, optionally 0.4:100, optionally 0.3:100, optionally 0.2:100, optionally 0.1:100, optionally 0.9:1000, optionally 0.8:1000, optionally 0.7:1000, optionally 0.6:1000, optionally 0.5:1000, optionally 0.4:1000, optionally 0.3:1000, optionally 0.2:1000, optionally 0.1:1000.

Alternatively, in some embodiments, a process of producing an electrically conducting polymer includes first mixing an oxidant and a solvent to form a solid oxidant-solvent complex. According to some such embodiments, the process then further includes polymerizing a plurality of chain monomers and optionally a plurality of cap monomers in the presence of the solid oxidant-solvent complex to form the electrically conductive polymer. In some embodiments, the electrically conductive polymer includes a cap on one or more ends of the polymer as otherwise described herein.

The oxidant that may be used in a process of producing an electrically conducting polymer as provided herein is optionally an oxidative coupling reagent that couples the electron donating aromatic monomer with the cap polymer. For example, without wishing to be bound by theory, the cap monomer may couple with the other monomers at the terminus of the polymer through C—C and/or C—O bond formation. Optionally, the oxidant is or includes iron or an iron derivative. For example, the oxidant is optionally an iron(III) salt. Illustratively, the oxidant may be iron(III) chloride, iron(III) chloride hydrate, and/or iron(III) p-toluene sulfonate hexahydrate. The oxidant may be added to the reaction mixture in excess, with respect to the monomers. For example, between at least 1 and less than or equal to 25 equivalents of oxidant may be added to the reaction mixture, with respect to the monomers. Optionally, less than 1 equivalent of oxidant is added to the reaction mixture, with respect to the monomers. For example, in some aspects, between at least 0.005 and less than 1 equivalent of oxidant is added to the reaction mixture, with respect to the monomers.

The solvent used during synthesis of the electrically conductive polymer may be any suitable solvent. In some aspects, a solvent may be an acetonitrile, carbonate, aromatics (e.g., benzene, mesitylene, pyridine, toluene, xylene, and the like), water, dichloromethane, chloroform, mixtures thereof, and/or derivatives thereof (e.g., chlorinated derivatives, fluorinated derivatives, and the like). Optionally, the electrically conductive polymer includes a trace amount (e.g. 1 wt % or less) of solvent (e.g., after forming the polymer, after drying of the polymer).

Any one of several possible general mechanisms of chemical synthesis may be performed to synthesize an electrically conductive polymer as provided herein keeping time and temperature into consideration as otherwise provided herein. Alternatively, an electrically conductive polymer may be synthesized by direct oxidative coupling with water wherein an oxidant is mixed with water and solvent along with monomers and cap monomers and reacted for the desired time and at the desired temperature as otherwise discussed herein followed by quenching optionally by dilution in 1:1 water/methanol. Alternatively, an electrically conductive polymer may be synthesized by direct arylation polymerization wherein monomers and cap monomers may be combined with potassium phosphate and dimethylacetamide followed by the addition of palladium acetate and pivalic acid for the desired time and at the desired temperature as otherwise discussed herein followed by quenching optionally by dilution in 1:1 water/methanol. The resulting polymers may be further treated by washing, filtration, and/or drying to form the final electrically conductive polymer.

After synthesis, the electrically conductive polymer may be in the form of a high viscosity slurry, a semi-solid composed of slurry and granular particles, or granular particles (e.g., prior to being disposed as an electrode in an energy storage device such as a capacitor). It is appreciated the electrically conductive polymer material may have any of a variety of suitable viscosities. The viscosity of the electrically conductive polymer material can be measured by using a viscometer, for example.

It was found that by producing the electrically conducting polymer as provided herein the degree of conjugation throughout the system can be improved thereby improving electrochemical performance of the polymer when used in an electrode. One measure of degree of conjugation is a ratio of 1437 cm⁻¹/1490 cm⁻¹ (defining Nc as used herein) measured by FTIR. By FTIR a peak at 1490 cm⁻¹ represents an asymmetric stretch in a polymer chain and a peak at 1437 cm⁻¹ by FTIR represents a C═C symmetric stretch. As the degree of conjugation increases in a polymer, the asymmetric stretch decreases as chain ends are less prevalent, which in turn drives an increase in symmetric stretch. Thus, the ratio of absorbance at 1437 cm⁻¹/1490 cm⁻¹ by FTIR correlates to a measure of conjugation in the polymer. Optionally, the ratio of 1437 cm⁻¹/1490 cm⁻¹ by FTIR is equal to or less than 1.1, optionally 1.0, optionally 0.9, optionally 0.8, optionally 0.7, optionally 0.6, optionally 0.5, optionally 0.4, optionally 0.3, optionally 0.2, optionally 0.1, optionally 0.05, optionally 0.01.

In some aspects, an electrically conductive polymer as provided herein is characterized by a ratio of absorbance at 690 cm⁻¹ to 1740 cm⁻¹ by FTIR of 50 or less. By FTIR the absorbance at 690 cm⁻¹ equates to the amount of monomer end groups (e.g. without a cap) and absorbance at 1740 cm⁻¹ by FTIR equates to the presence of a carbonyl peak representing a cap structure on the end of the polymer. Thus, by increasing the presence of the cap, the absorbance at 1740 cm⁻¹ by FTIR will increase driving the ratio of absorbance at 690 cm⁻¹ to 1740 cm⁻¹ by FTIR lower. Optionally, the ratio of absorbance at 690 cm⁻¹ to 1740 cm⁻¹ by FTIR is 50 or less. Optionally, the ratio of absorbance at 690 cm⁻¹ to 1740 cm⁻¹ by FTIR is equal to or less than 49, 45, 40, 35, 30, 25, 20, 15, 10, 9, 8, 7, 6, 5, 4, or less. In some aspects, the ratio of absorbance at 690 cm⁻¹ to 1740 cm⁻¹ by FTIR is 10 or less. In some aspects, the ratio of absorbance at 690 cm⁻¹ to 1740 cm⁻¹ by FTIR is 30 or less.

During the manufacture of the electrically conductive polymer, particularly where an iron salt is used in oxidative coupling, impurities may be bound to or otherwise remain with the electrically conductive polymer. These impurities, such as residual Fe, may be locked inside polymer particles as they form in a homogeneous solution. As the polymer grows it becomes non-tractable in the solvent system (any solvent [symbol] protic, aprotic, or aqueous) and drops out of solution. The presence of the iron affects energy storage performance by imposing structural defects within the electrically conductive polymer such as possible twisting the conjugation to be out plane and possibly thereby introducing a kink in the material. As such, in some aspects, the presence of Fe in the final product is at or less than 1 mole % relative to the moles of chain monomer, optionally at or less than 0.1 mol %, optionally at or less than 0.01 mole %.

The electrically conductive polymer may be post-processed into a film. For example, the electrically conductive polymer in the form of granular particles may be rolled and/or pressed into a film alone or in the presence of other materials such as but not limited to a binder or a conductive agent. Alternatively, the electrically conductive polymer in the form of a slurry or semi-solid composed of slurry and granular particles may be coated onto a conductive substrate (e.g., aluminum foil) and dried, optionally alone or in the presence of other materials such as but not limited to a binder or a conductive agent.

The electrically conductive polymer that has been processed into film may be used as an active portion of an electrode in an energy storage device (e.g., a battery or supercapacitor) wherein the film is in electrical communication with a current collector. In some embodiments, the electrically conductive polymer film may include an electrically conductive polymer having a cap. In addition to the electrically conductive polymer having a cap, the electrically conductive polymer film may include one or more oxidants (e.g., trace amounts), and/or one or more solvents (e.g., trace amounts), in some cases. In some aspects, the electrically conductive polymer film may include crystalline polymers (e.g., a solid state structure). According to some embodiments, the electrically conductive polymer film may include amorphous polymers.

An electrically conductive polymer may be employed as a portion of an electrode. An electrode is optionally an anode or a cathode. An electrode as provided herein, may include a current collector and a film including the electrically conductive polymer as provided herein wherein the electrically conductive polymer optionally is in electrical contact with the current collector. In the formation of an electrode, one more additives may be added to the electrically conductive polymer film. An additive may be any compound or material suitable for use in an electrode including but not limited to a binder, a conductive agent, an electrochemically active material, solvent, or other.

An electrochemically active material alone or in combination with an electrically conducting polymer as provided herein are optionally in a powder or particulate form. The particles may be held together by a binder to form a layer on a current collector in the formation of the anode or cathode. A binder suitable for use in forming an anode, a cathode or both is optionally any binder known in the art suitable for such purposes.

A film for use in an electrode optionally includes an electrically conductive polymer and a binder. The binder may serve to improve the adhesion of the electrically conducive polymer and/or provide desired film characteristics such as but not limited to elasticity, tensile strength or other. A binder is optionally any binder suitable in the art of secondary batteries or supercapacitors, optionally but not limited to polymeric binder materials. Optionally a binder material is an elastomeric material, optionally styrene-butadiene (SB), styrene-butadiene-styrene block copolymer (SBS), styrene-isoprene-styrene block copolymer (SIS) and styrene-ethylene-butadiene-styrene block copolymer (SEBS). Illustrative specific examples of a binder include, but are not limited to polytetrfluoroethylene (PTFE), polyvinyl alcohol (PVA), teflonized acetylene black (TAB-2), styrene-butadiene binder materials, or/and carboxymethyl cellulose (CMC). The weight ratio of electrically conductive polymer to binder is optionally from 4:1 to 1:4. Optionally, the binder is present with the electrically conductive polymer at 10 wt % or lower, optionally 9 wt % or lower, optionally 8 wt % or lower, optionally 7 wt % or lower, optionally 6 wt % or lower, optionally 5 wt % or lower, optionally 4 wt % or lower, optionally 3 wt % or lower, optionally 2 wt % or lower, optionally 1 wt % or lower.

An electrode including an electrically conductive polymer as provided herein may further include one or more conductive materials intermixed with the electrically conductive polymer. A conductive material is optionally a conductive carbon. Illustrative examples of a conductive carbon include graphite. Other examples are materials that contain graphitic carbons, such as graphitized cokes. Still other examples of possible carbon materials include non-graphitic carbons that may be amorphous, non-crystalline, and disordered, such as petroleum cokes and carbon black. A conductive material is optionally present in a film at a weight percent (wt %) of 0.1 wt % to 75 wt %, or any value or range therebetween. Optionally, the weight percent of the conductive material is 4 wt % to 60 wt %, or any value or range therebetween. Optionally, the weight percent of the conductive material is 10 wt % to 60 wt %, or any value or range therebetween. Optionally, the weight percent of the conductive material is 20 wt % to 60 wt %, or any value or range therebetween.

An electrode as provided herein may include an electrically conductive polymer and one or more electrochemically active materials. An electrochemically active material as defined herein is one that is capable of absorbing or desorbing an ion or a proton, optionally lithium, sodium, potassium, or hydrogen. Illustrative examples of electrochemically active materials include but are not limited to carbons such as graphite or other carbon materials, and transition metal oxides or hydroxides. Optionally, an electrochemically active material excludes carbon.

In some aspects, an electrode including an electrically conducting polymer as provided herein further includes an electrochemically active material intermixed therewith or in a layer in electrical or electrochemical communication with the electrically conductive polymer.

A cathode electrochemically active material that may be included in an electrode with an electrically conducting polymer is optionally a hydroxide of Ni alone or in combination with one or more additional metals. Optionally, an electrochemically active material includes Ni and 1, 2, 3, 4, 5, 6, 7, 8, 9, or more additional metals that may include transition metals, post-transition metals or metalloids. Optionally, a cathode electrochemically active material includes Ni as the sole metal, optionally Ni combined with one or more transition metals, post-transition metals or metalloids. In some aspects, the cathode electrochemically active material includes one or more metals selected from the group of Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, a hydride thereof, an oxide thereof, a hydroxide thereof, an oxyhydroxide thereof, or any combination of the foregoing. Optionally, a cathode electrochemically active material includes one or more of Ni, Co, Mn, Zn, Al, Zr, Mo, Mn, a rare earth, or combinations thereof. In some aspects, a cathode electrochemically active material includes Ni, Co, Al, or combinations thereof. Ni is optionally present at 10 atomic percent (at %) or greater, optionally 80 atomic percent or greater, optionally 90 at % or greater, optionally 95 at % or greater. Optionally, Ni is the sole metal in the electrochemically active material.

An anode electrochemically active material that may be included herein is optionally any suitable carbon, such as graphite, coke, a hard carbon, or a mesocarbon such as a mesocarbon microbead, for example. Optionally, an anode electrochemically active material is a high surface area carbon with a ratio of surface area to mass of 800 m²/g or greater. Optionally, an anode includes a metal or other element. Optionally, an anode active material is Li or a lithium metal material such as lithium titanium oxide. It is appreciated that other anode electrochemically active materials as known in the art may be employed as well.

An electrode may be formed by any method known in the art such as by slurry formation and coating or dry coating processes. For example, an electrically conducting polymer alone or with another material may be combined with a binder, and optionally conductive material, in an appropriate solvent to form a slurry. The slurry may be coated onto a current collector and dried to evaporate some or all of the solvent to thereby form a film layer on the surface of the current collector.

An electrode as provided herein includes a current collector. A current collector may be in the form of a mesh, foil, or other suitable form. A current collector is optionally in the form of a sheet, and may be in the form of a foil, solid substrate, porous substrate, grid, foam or foam coated with one or more metals, or other form known in the art. In some aspects a current collector is in the form of a foil. Optionally, a grid may include expanded metal grids and perforated foil grids.

A current collector may be formed of any material that is suitable conductive of electrons to be used in an electrode. A current collector is optionally formed of any suitable electronically conductive and optionally impermeable or substantially impermeable material, including, but not limited to stainless steel, titanium, copper, or carbon papers/films, a non-perforated metal foil, aluminum foil, cladding material including nickel and aluminum, cladding material including copper and aluminum, nickel plated steel, nickel plated copper, nickel plated aluminum, gold, silver, any other suitable electronically conductive and impermeable material or any suitable combination thereof. Optionally, a current collector may be formed of one or more suitable metals or combination of metals (e.g., alloys, solid solutions, plated metals). Optionally, a current collector may be formed of aluminum, such as an aluminum alloy, nickel or nickel alloy, steel such as stainless steel, copper or copper alloys, or other such material.

The current collector may include or be in electrical communication with one or more tabs to allow the transfer of electrons from the current collector to a region exterior of the electrode and to connect the current collector(s) to a circuit so that the electrons produced during discharge of any cell or device employing the electrode may be used to power one or more devices or otherwise deliver electrical energy to any system (e.g. power grid). A tab may be formed of any suitable conductive material (e.g. Ni, Al, or other metal) and may be welded onto the current collector. Optionally, each electrode has a single tab.

An electrode may be employed in a device, optionally a battery or supercapacitor, as a portion of a cathode or anode. Optionally, an electrode is employed in a device as a cathode. A device may include a housing that further includes a separator, and electrolyte, or both. A separator may be placed adjacent (e.g., directly adjacent) to the electrode and a second electrode, optionally dispersed between an anode and a cathode. A separator may be capable of transferring lithium therethrough. An electrolyte may be arranged between first electrode and second electrode (e.g., via the separator material), such that the electrolyte is in contact with both first electrode and second electrode. A separator may be a microporous membrane, and may include a porous film including polypropylene, polyethylene, or a combination thereof, or may be a woven or non-woven material such a glass-fiber mat.

A device may further include an electrolyte. Any suitable electrolyte may be used. The electrolyte may be arranged to be in electrochemical communication with the first and second electrodes (e.g., the first electrode and second electrode are in contact with a common electrolyte). The electrolyte can be any of a variety of materials capable of transporting either positively or negatively charged ions, or a proton between two electrodes and should be chemically compatible with the electrodes. In some cases, the electrolyte is selected to be capable of supporting high charge stabilization.

Optionally, the electrolyte is a liquid electrolyte. As a non-limiting example, the electrolyte may be or include an ionic liquid. For example, the electrolyte may be 1-ethyl-3-methylimidazolium tetrafluoroborate. Other examples of electrolytes include a non-aqueous organic solvent. Optionally an electrolyte includes ethylene carbonate solutions, dimethyl carbonate solutions, dimethyl carbonate, ethyl methyl carbonate, diethyl carbonate, ethylene carbonate, propylene carbonate, acetonitrile, lithium, sodium, or potassium salt containing electrolytes, and/or propylene carbonate solutions, which include but are not limited to at least one salt having the formula, [(R)₄N⁺] [symbol] ], wherein X is [symbol] , [symbol] , [symbol] , [symbol] N [symbol] SO₂R^{a}) [symbol] , or (CF₃)₂CHO) [symbol] , wherein R is alkyl and R^{a} is alkyl, aryl, fluorinated alkyl, or fluorinated aryl. Optionally, the liquid electrolyte may include N-ethyl-N-(₂-methoxyethyl)-N,N-dimethylammonium tetrafluoroborate. Optionally, the electrolyte may be a solid ceramic electrolyte. Optionally, and electrolyte includes a lithium salt, optionally LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiCl, LiI, or LiB(C₂O₄)₂ (lithium bis(oxalato)borate; LiBOB).

The anode, cathode, separator, and electrolyte may be housed in a cell case (e.g. housing). The housing may be in the form of a metal or polymeric can, or can be a laminate film, such as a heat-sealable aluminum foil, such as an aluminum coated polypropylene film. The device may have any suitable configuration or shape, and may be cylindrical or prismatic.

A device may be charged and/or discharged during normal operation. According to certain embodiments, the energy storage device may have to be charged and/or discharged in order to store energy (e.g., as energy density of the device). Therefore, in certain embodiments, the device can be charged and/or discharged at a potential window between 0 V and 6.5 V. According to some embodiments, the potential window may change depending on the composition of components in the energy storage device.

Various aspects of the present disclosure are illustrated by the following non-limiting examples. The examples are for illustrative purposes and are not a limitation on any practice of the present invention. It will be understood that variations and modifications can be made without departing from the spirit and scope of the invention.

### EXPERIMENTAL

### Example 1

Various mixtures of thiophene (1.68 g, 0.02 M) and phenol (84 mg, 0.89 mmol) were added to a cooled solution (˜0° C.) of anhydrous iron (III) chloride (17 g, 0.1 mol) in acetonitrile (27 ml). The mixtures resulted dark colored suspension that were independently stirred at ˜0° C. for 15 to 2 hours, during which time dark greenish solids separated out. The reactions were quenched by addition of 1:1 water: methanol mixture. The polymer solids were collected by filtration and washed with water until the filtrate was pale colored. The partially de-doped solids were further washed with methanol, followed by an acetone and THE wash to remove oligomers and homo-polymers of phenol. The dark brown colored solids were treated with 10% ammonium hydroxide solution. The reddish-brown colored solids obtained were further filtered, washed with water and methanol, dried in vacuum at 50° C. The resulting yield of electrically conductive polymer was 1.04 g (60%).

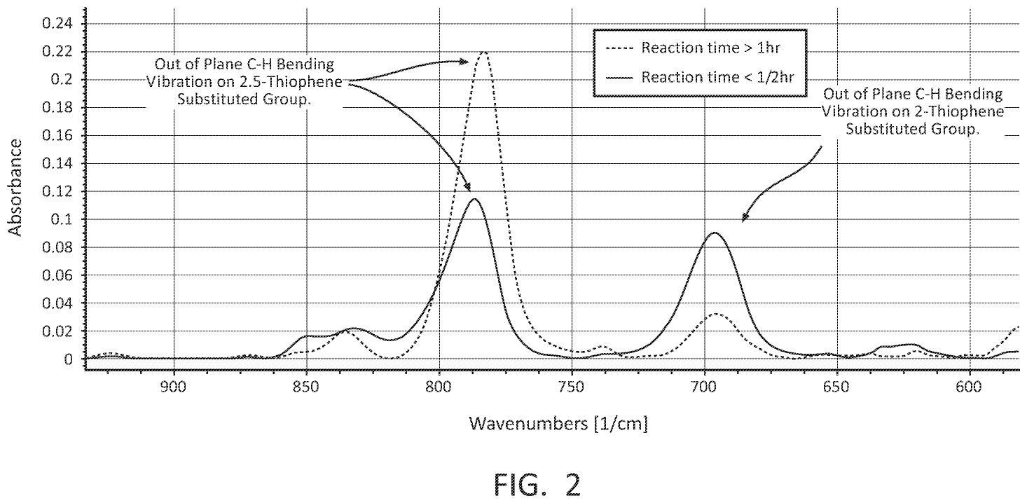

The resulting polymers were subjected to analyses by Fourier transform infrared spectroscopy by standard methods optionally using a Thermo-Nicolet FT-IR instrument, model 6700 with a Smart Orbit Diamond ATR. Resulting spectra from two samples reacted for either less than 30 minutes or greater than 1 hour are depicted in FIG. 2. In these studies, the vibrational band at 781 cm⁻¹ is assigned to the 2,5 substituted thiophene out of plane C—H vibration, and the vibrational band at 690 cm⁻¹ is assigned to the 2-substituted C—H out of plane bending vibration. For these materials, kinked or branched polymers may show a high degree of polymerization but a high degree of polymerization does not equate to a high degree of conjugation. For such long polymers without sufficient conjugation there will be a greater 2-substituted C—H out of plane bending vibration signal. These data show that for longer reaction times, while a greater degree of polymerization may be achieved, this does not equate to a greater degree of conjugation.

### Example 2

The reaction conditions of Example 1 were repeated by further addition of various amounts of phenol from 1 wt % to 10 wt % along with the other monomers in the system. Reaction times were identical to those of Example 1.

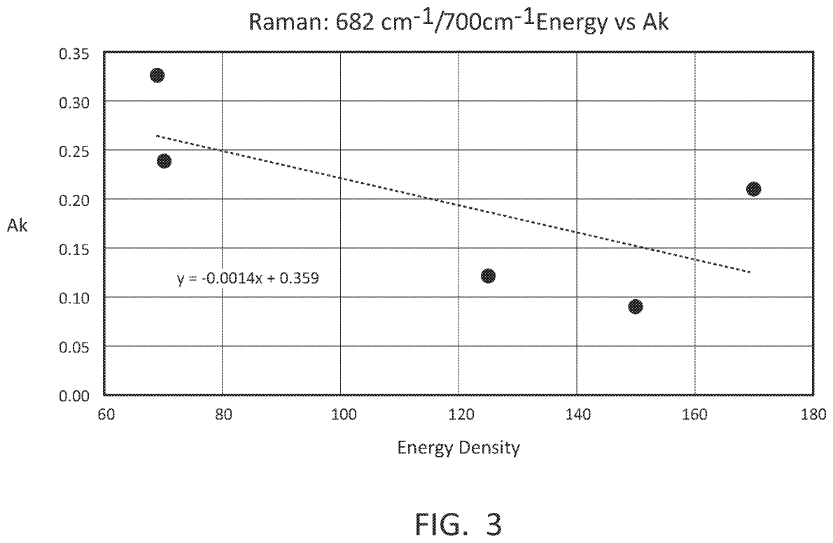

The resulting polymers were subjected to studies by Raman spectroscopy by standard techniques optionally using a Bruker micro Raman instrument with 532 nm laser used at 0.25 mW. Resulting spectra for materials produced by reaction for various times are illustrated in FIG. 3 illustrating that as the kinking factor (peak intensity ratio of 682 cm⁻¹/700 cm⁻¹) decreases the resulting energy density of the electrically conductive polymer increases with excellent overall energy density achieved at a kinking factor of 0.25 or lower. Energy density in these studies was performed by utilizing the electrically conductive polymer in a cathode in a pouch cell with a 20 micron cellulosic NKK separator with 1 Molar TEA-PF6 in propylene carbonate as the electrolyte. The Anode material was Kuraray YP-80 made with a conductive additive (Imerys SP carbon, 8 w/w % and Teflon emulsion, 5 w/w %).

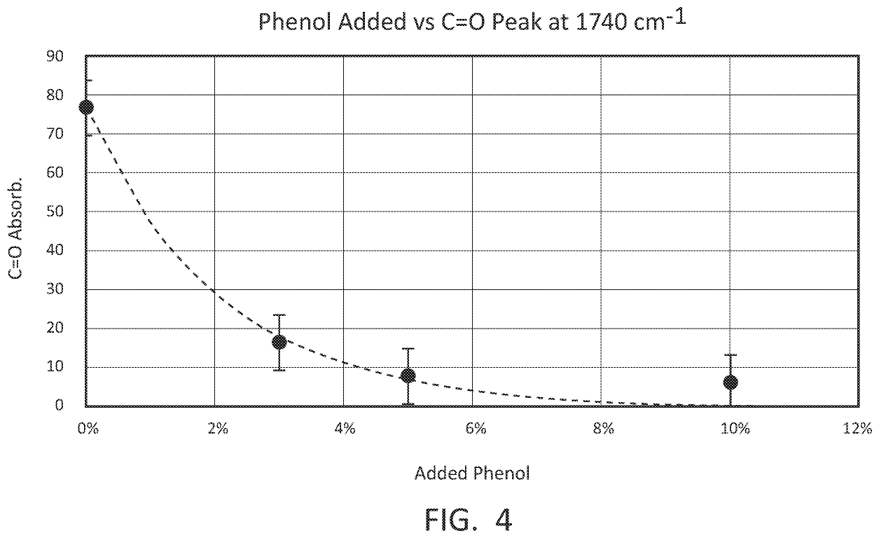

The polymers were further studied by FTIR by standard techniques. FIG. 4 illustrates the ester C═O absorbance peak at 1740 cm⁻¹ relative to added phenol concentrations. As the amount of phenol reaches only 1-3 wt % the normalized absorbance of the ester peak is decreased demonstrating that improved conjugation is achieved at low phenol concentrations which is substantially fully achieved at 5 wt % phenol or lower.

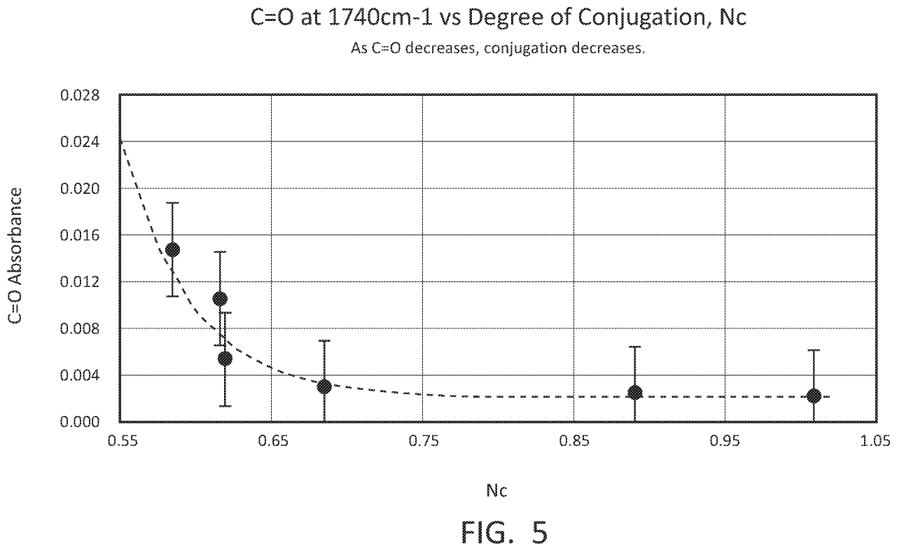

The degree of conjugation as measured by FTIR is a ratio of the peak absorbances at 1437 cm⁻¹/1490 cm⁻¹ wherein the quantity Nc indicates the degree of conjugation so that 1/Nc trends to higher numbers for higher degrees of conjugation. As illustrated in FIG. 5, the carbonyl stretch associated with an ester at 1740 cm⁻¹ dramatically increases as conjugation increases correlating well with FIG. 4 demonstrating excellent conjugation with low levels of phenol when electrically conductive polymers are prepared with low levels of kinking as provided herein.

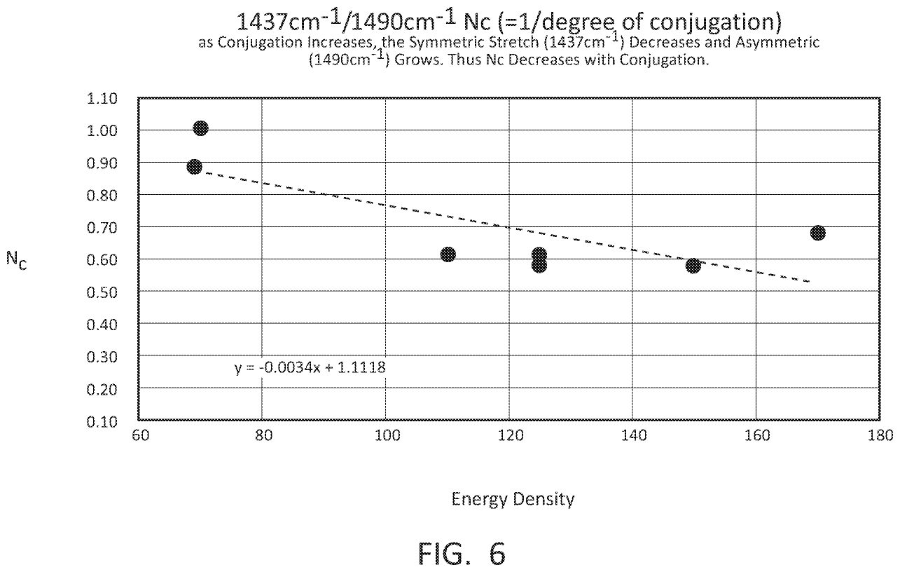

The degree of conjugation Nc when decreased also leads to improved energy density. As illustrated in FIG. 6, as Nc decreases energy density significantly increases with improvements observed at an Nc of 1.1 or smaller.

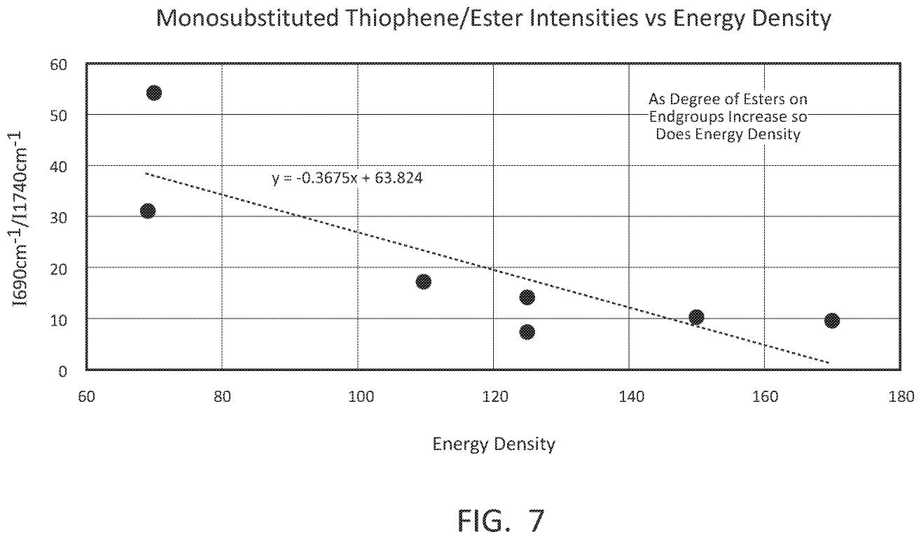

Further, the degree of ester formation in a capped electrically conductive polymer is a measure of conductive polymer formation. When the intensity of the peak of monosubstituted thiophene at 690 cm⁻¹ relative to the C═O of the ester measured at 1740 cm⁻¹, a clear correlation is observed between the reduction in monosubstituted thiophene (e.g. monomer) to conductive polymer ratio and energy density as measured in a pouch cell. FIG. 7 illustrates that at a peak intensity (e.g. absorbance) ratio of 690 cm⁻¹ to 1740 cm⁻¹ by FTIR of 50 or less, excellent energy density is achieved.

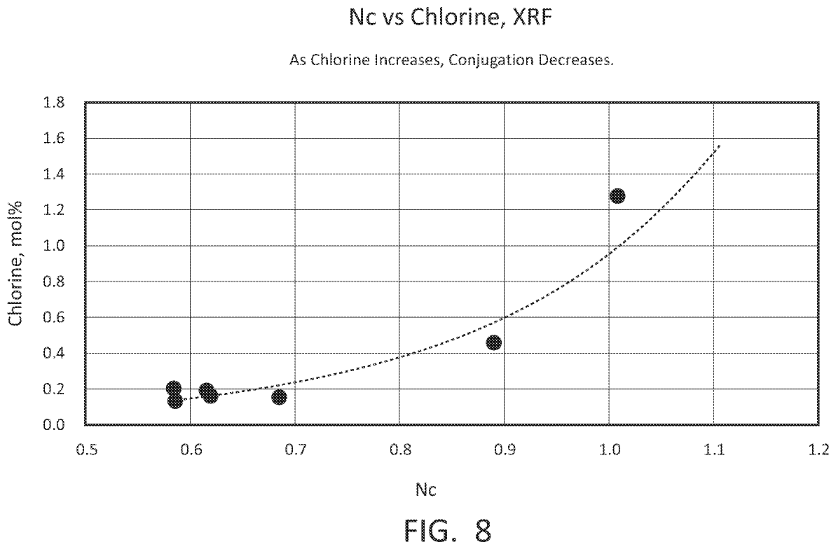

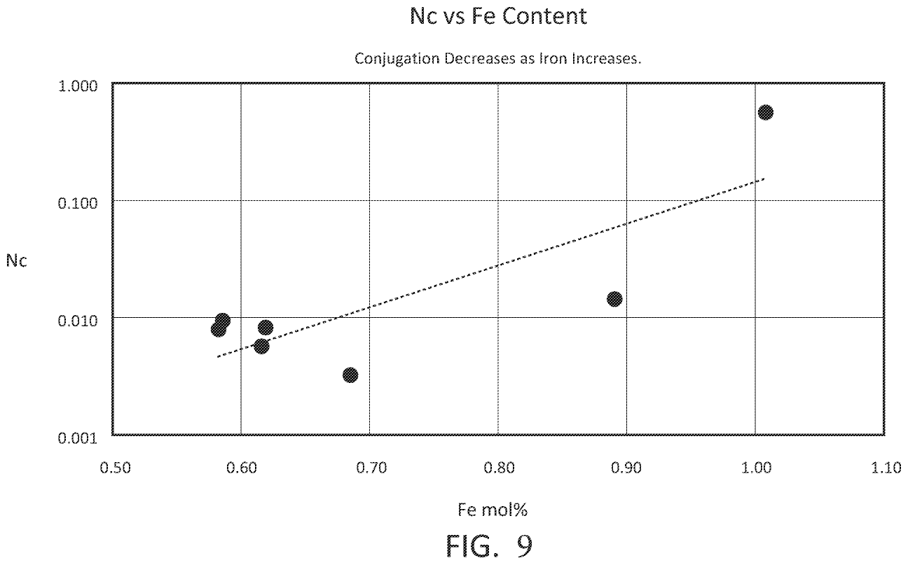

During manufacture of electrically conductive polymers according to some methods as provided herein, the presence of halogens such as chlorine, or metals such as iron serve as contaminants to optimal conjugation within an electrically conductive polymer. When the amount of chlorine is reviewed with respect to the degree of conjugation (Nc), it was found that at a molar percentage of 0.25 or lower of Cl to monomer, excellent conjugation is observed. FIG. 8 illustrates that 1/Nc increases as Cl concentration remaining in the polymer post-manufacture increases where Cl concentration was measured using XPS and XRF. Following manufacture, the resulting polymers were purified by water washing followed by ethanol washing to remove the most residual Cl ion from the system. The remaining Cl observed in these studies demonstrates halogen that is unable to be fully removed by post-synthesis purification steps demonstrating that some halogen is deeply embedded within the electrically conductive polymer itself, but that its removal is desired and correlates with improved conductivity. Similarly, as is illustrated in FIG. 9, Fe levels are inversely correlated with a degree of conjugation whereby as the amount of residual Fe decreases, the resulting degree of conjugation, Nc, increases. It is noted that SEM of samples with higher residual Fe in the system appear to show the presence of multiple phases within the system (data not shown).

The foregoing description of particular aspect(s) is merely exemplary in nature and is in no way intended to limit the scope of the invention as claimed below, its application, or uses, which may, of course, vary. The disclosure is provided with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being lonl another element, it can be directly on the other element or intervening elements may be present therebetween. In contrast, when an element is referred to as being I directly onl another element, there are no intervening elements present.

It will be understood that, although the terms [symbol] first [symbol] , [symbol] second, [symbol] [symbol] third [symbol] etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, [symbol] a first element, [symbol] [symbol] component, [symbol] [symbol] region, [symbol] [symbol] layer, [symbol] or [symbol] section [symbol] discussed below could be termed a second (or other) element, component, region, layer, or section without departing from the teachings herein.

The terminology used herein is for the purpose of describing particular embodiments only and is not intended to be limiting. As used herein, the singular forms [symbol] a, [symbol] [symbol] an, [symbol] and [symbol] the [symbol] are intended to include the plural forms, including [symbol] at least one, [symbol] unless the content clearly indicates otherwise. [symbol] Or [symbol] means [symbol] and/or [symbol] As used herein, the term [symbol] and/or [symbol] includes any and all combinations of one or more of the associated listed items. It will be further understood that the terms [symbol] comprises [symbol] and/or [symbol] comprising, [symbol] or [symbol] includes [symbol] and/or [symbol] including [symbol] when used in this specification, specify the presence of stated features, regions, integers, steps, operations, elements, and/or components, but do not preclude the presence or addition of one or more other features, regions, integers, steps, operations, elements, components, and/or groups thereof. The term [symbol] or a combination thereof [symbol] means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

In view of the foregoing, it is to be understood that other modifications and variations of the present invention may be implemented. The foregoing drawings, discussion, and description are illustrative of some specific embodiments of the invention but are not meant to be limitations upon the practice thereof. It is the following claims, including all equivalents, which define the scope of the invention.

1. An electrode comprising:
a current collector; and
a film comprising an electrically conductive polymer comprising a plurality of monomers, wherein the plurality of monomers are conjugated in a polymeric linkage with a kinking factor of 0.25 or less.

2. The electrode of claim 1, wherein said plurality of monomers comprise heteromeric monomers.

3. The electrode of claim 1, wherein said plurality of monomers comprise homomeric monomers.

4. The electrode of claim 1, wherein said monomers comprise five-or six-membered ring structures.

5. The electrode of claim 1, wherein said plurality of monomers comprise aromatic monomers.

6. The electrode of claim 1, wherein at least some of said monomers further comprise a non-hydrogen substituent.

7. The electrode of claim 6, wherein said non-hydrogen substituent comprises a halogen atom, or a linear or branched alkyl, alkoxy, or alkyl ester group having from 1 to 20 carbon atoms.

8. The electrode of claim 7, wherein said non-hydrogen substituent comprises a C1-C5 alkyl ester.

9. The electrode of any one of claims 1-8, further comprising a cap on one or both ends of the electrically conductive polymer.

10. The electrode of claim 9, wherein said cap comprises a substituted or unsubstituted aromatic moiety.

11. The electrode of claim 9, wherein cap comprises a phenolic moiety.

12. The electrode of claim 9, wherein said cap further comprise a non-hydrogen substituent.

13. The electrode of claim 12, wherein said cap comprises a substituted aromatic moiety with a substituent selected from the group consisting of a halogen atom, or linear or branched alkyl, alkoxy, or alkyl ester group having from 1 to 20 carbon atoms.

14. The electrode of any one of claims 1-8, wherein said monomers comprise a heterocyclic structure.

15. The electrode of claim 14, wherein said heterocyclic structure comprises a heteroatom selected from the group consisting of N, O, S, or P.

16. The electrode of any one of claims 1-8, wherein said monomer comprises a substituted or unsubstituted pyrrole, thiophene, aniline, phenyl, mixtures thereof, and/or derivatives thereof.

17. The electrode of claim 16, wherein said monomer comprises a thiophene, a phenol, or combinations thereof.

18. The electrode of any one of claims 1-8, wherein said electrically conductive polymer comprises a ratio of absorbance at 690 cm⁻¹ to 1740 cm⁻¹ by FTIR of 50 or less.

19. The electrode of any one of claims 1-8, wherein said electrically conductive polymer comprises a ratio of absorbance at 1437 cm⁻¹/1490 cm⁻¹ by FTIR of 1.1 or less.

20. The electrode of any one of claims 1-8, wherein one or more of said monomers comprises a halogen and alkyl ester or combinations thereof, and wherein one or more of said monomers comprises a sulfur.

21. The electrode of claim 20, wherein a molar percentage of said halogen to said sulfur is 0.25 or lower.

22. The electrode of any one of claims 1-8 for use in an electrochemical cell.

23. The electrode of any one of claims 1-8, wherein said current collector comprises Al, Cu, or a combination thereof.

24. The electrode of claim 23, wherein said current collector comprises Al.

25. The electrode of any one of claims 1-8 further comprising an electrochemically active material intermixed within or layered on said film.

26. The electrode of claim 25, wherein said electrochemically active material comprises carbon or transition metal oxides or hydroxides.

27. An electrode comprising:
a current collector; and
a film comprising the electrically conductive polymer comprising a plurality of monomers, said electrically conductive polymer comprising a cap on one or both ends of the electrically conductive polymer.

28. The electrode of claim 27, wherein said cap comprises a substituted or unsubstituted aromatic moiety.

29. The electrode of claim 27, wherein cap comprises a phenolic moiety.

30. The electrode of claim 27, wherein said cap further comprises a non-hydrogen substituent.

31. The electrode of claim 27, wherein said end cap comprises a substituted aromatic moiety with a substituent selected from the group consisting of a halogen atom, or linear or branched alkyl, alkoxy, or alkyl ester group having from 1 to 20 carbon atoms.

32. The electrode of any one of claims 27-31, wherein said plurality of monomers comprise heteromeric monomers.

33. The electrode of any one of claims 27-31, wherein said plurality of monomers comprise homomeric monomers.

34. The electrode of any one of claims 27-31, wherein said monomers comprise five-or six-membered ring structures.

35. The electrode of any one of claims 27-31, wherein said plurality of monomers comprise aromatic monomers.

36. The electrode of any one of claims 27-31, wherein at least some of said monomers further comprise a non-hydrogen substituent.

37. The electrode of claim 36, wherein said non-hydrogen substituent comprises a halogen atom, or a linear or branched alkyl, alkoxy, or alkyl ester group having from 1 to 20 carbon atoms.

38. The electrode of claim 37, wherein said non-hydrogen substituent comprises a C1-C5 alkyl ester.

39. The electrode of any one of claims 27-31, wherein said monomers comprise a heterocyclic structure.

40. The electrode of claim 39, wherein said heterocyclic structure comprises a heteroatom selected from the group consisting of N, O, S, or P.

41. The electrode of any one of claims 27-31, wherein said monomers comprise a substituted or unsubstituted pyrrole, thiophene, aniline, phenyl, mixtures thereof, and/or derivatives thereof.

42. The electrode of claim 41, wherein said monomers comprise a thiophene, a phenol, or combinations thereof.

43. The electrode of any one of claims 1-8 or 27-31, wherein said electrically conductive polymer comprises a ratio of absorbance at 690 nm to 1740 nm by FTIR of 50 or less.

44. The electrode of any one of claims 1-8 or 27-31, electrically conductive polymer comprises a ratio of absorbance at 682 cm⁻¹ to 700 cm⁻¹ by Raman spectroscopy of 0.3 or less.

45. The electrode of any one of claims 1-8 or 27-31, wherein one or more of said monomers comprises a halogen and alkyl ester or combinations thereof, and wherein one or more of said monomers comprises a sulfur.

46. The electrode of claim 45, wherein a molar percentage of said halogen to said sulfur is 0.25 or lower.

47. The electrode of any one of claims 1-8 or 27-31 for use in an electrochemical cell.

48. The electrode of any one of claims 1-8 or 27-31, wherein said current collector comprises Al, Cu, or a combination thereof.

49. The electrode of any one of claims 1-8 or 27-31 further comprising an electrochemically active material intermixed within or layered on said film.

50. An electrochemical cell comprising:
the electrode of any one of claims 1-8 or 27-31 as a cathode;
an anode;
a separator dispersed between said anode and said cathode; and
an electrolyte.

51. The electrochemical cell of claim 50, wherein said anode is capable of absorbing and desorbing lithium.

52. The electrochemical cell of claim 50, wherein said separator is capable of transferring lithium.

53. The electrochemical cell of claim 50, wherein said electrolyte comprises a lithium salt and a non-aqueous organic solvent.

54. The electrochemical cell of claim 53, wherein said lithium salt is LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiCl, LiI, or LiB(C₂O₄)₂ (lithium bis(oxalato)borate; LiBOB).

55. The electrochemical cell of claim 53, wherein said organic solvent is optionally a borate, a carbonate, or combinations thereof.

56. An electrically conductive polymer comprising:
a plurality of monomers linked to form said electrically conductive polymer, said electrically conductive polymer further comprising a cap on one or both ends of the electrically conductive polymer.

57. The electrically conductive polymer of claim 56, wherein said cap comprises a substituted or unsubstituted aromatic moiety.

58. The electrically conductive polymer of claim 56, wherein cap comprises a phenolic moiety.

59. The electrically conductive polymer of claim 56, wherein said cap further comprises a non-hydrogen substituent.

60. The electrically conductive polymer of claim 56, wherein said cap comprises a substituted aromatic moiety with a substituent selected from the group consisting of a halogen atom, or linear or branched alkyl, alkoxy, or alkyl ester group having from 1 to 20 carbon atoms.

61. The electrically conductive polymer of any one of claims 56-60, wherein said plurality of monomers comprise heteromeric monomers.

62. The electrically conductive polymer of any one of claims 56-60, wherein said plurality of monomers comprise homomeric monomers.

63. The electrically conductive polymer of any one of claims 56-60, wherein said monomers comprise five-or six-membered ring structures.

64. The electrically conductive polymer of any one of claims 56-60, wherein said plurality of monomers comprise aromatic monomers.

65. The electrically conductive polymer of any one of claims 56-60, wherein at least some of said monomers further comprise a non-hydrogen substituent.

66. The electrically conductive polymer of claim 65, wherein said non-hydrogen substituent comprises a halogen atom, or a linear or branched alkyl, alkoxy, or alkyl ester group having from 1 to 20 carbon atoms.

67. The electrically conductive polymer of claim 66, wherein said non-hydrogen substituent comprises a C1-C5 alkyl ester.

68. The electrically conductive polymer of any one of claims 56-60, wherein said monomers comprise a heterocyclic structure.

69. The electrically conductive polymer of claim 68, wherein said heterocyclic structure comprises a heteroatom selected from the group consisting of N, O, S, or P.

70. The electrically conductive polymer of any one of claims 56-60, wherein said monomers comprise a substituted or unsubstituted pyrrole, thiophene, aniline, phenyl, mixtures thereof, and/or derivatives thereof.

71. The electrically conductive polymer of claim 70, wherein said monomers comprise a thiophene, a phenol, or combinations thereof.

72. The electrically conductive polymer of any one of claims 56-60, comprising a ratio of absorbance at 690 cm⁻¹ to 1740 cm⁻¹ by FTIR of 50 or less.

73. The electrically conductive polymer of any one of claims 56-60, comprising a ratio of absorbance at 682 cm⁻¹ to 700 cm⁻¹ by Raman spectroscopy of 0.25 or less.

74. The electrically conductive polymer of any one of claims 56-60, wherein one or more of said monomers comprises a halogen and alkyl ester or combinations thereof, and wherein one or more of said monomers comprises a sulfur.

75. The electrically conductive polymer of claim 74, wherein a molar percentage of said halogen to said sulfur is 0.25 or lower.

76. A process of forming an electrically conductive polymer comprising:
intermixing a plurality of cap monomers and chain monomers a molar ratio of 10:100 or less, and
polymerizing said monomers at a polymerization temperature for a polymerization time of one hour or less,
wherein said cap monomers differ structurally from said monomers.

77. The process of claim 76 wherein said polymerization time is 30 minutes or less.

78. The process of claim 76, wherein said polymerization time is 15 minutes or less.

79. The process of claim 76, wherein said temperature is 200° C. or less.

80. The process of claim 76, wherein said electrically conductive polymer comprises a Cl:S ratio of 0.25 or less.

81. The process of any one of claims 76-80, wherein the plurality of monomers are conjugated in a polymeric linkage with a kinking factor of 0.25 or less.

82. The process of any one of claims 76-80, wherein said plurality of monomers comprise heteromeric monomers.

83. The process of any one of claims 76-80, wherein said plurality of monomers comprise homomeric monomers.

84. The process of any one of claims 76-80, wherein said plurality of monomers comprise five-or six-membered ring structures.

85. The process of any one of claims 76-80, wherein said plurality of monomers comprise aromatic monomers.

86. The process of any one of claims 76-80, wherein at least some of said monomers further comprise a non-hydrogen substituent.

87. The process of any one of claims 76-80, wherein said non-hydrogen substituent comprises a halogen atom, or a linear or branched alkyl, alkoxy, or alkyl ester group having from 1 to 20 carbon atoms.

88. The process of claim 86, wherein said non-hydrogen substituent comprises a C1-C5 alkyl ester.

89. The process of any one of claims 76-80, further comprising a cap on one or both ends of the electrically conductive polymer.

90. The process of claim 89, wherein said cap comprises a substituted or unsubstituted aromatic moiety.

91. The process of claim 89, wherein cap comprises a phenolic moiety.

92. The process of claim 89, wherein said cap further comprise a non-hydrogen substituent.

93. The process of claim 89, wherein said cap comprises a substituted aromatic moiety selected from the group consisting of a halogen atom, or linear or branched alkyl, alkoxy, or alkyl ester group having from 1 to 20 carbon atoms.

94. The process of any one of claims 76-80, wherein said monomers comprises a heterocyclic structure.

95. The process of claim 94, wherein said heterocyclic structure comprises a heteroatom selected from the group consisting of N, O, S, or P.

96. The process of any one of claims 76-80, wherein said monomer comprises a substituted or unsubstituted pyrrole, thiophene, aniline, phenyl, mixtures thereof, and/or derivatives thereof.

97. The process of claim 96, wherein said monomer comprises a thiophene, a phenol, or combinations thereof.

98. The process of any one of claims 76-80, wherein said electrically conductive polymer comprises a ratio of absorbance at 690 cm⁻¹ to 1740 cm⁻¹ by FTIR of 50 or less.

99. The process of any one of claims 76-80, wherein said electrically conductive polymer comprises a ratio of absorbance at 682 cm⁻¹ to 700 cm⁻¹ by Raman spectroscopy of 0.3 or less.

100. The process of any one of claims 76-80, wherein one or more of said monomers comprises a halogen and alkyl ester or combinations thereof, and wherein one or more of said monomers comprises a sulfur.

101. The process of claim 100, wherein a molar percentage of said halogen to said sulfur is 0.25 or lower.
